(19) United States
(12) Patent Application Publication
(10) Pub. No.: US 2015/0140262 A1
(43) Pub. Date: May 21, 2015

(54) INSULATION LAYER STRUCTURE

(71) Applicant: KINSUS INTERCONNECT TECHNOLOGY CORP., Taoyuan (TW)

(72) Inventors: Yu-Hsiang SUN, Taichung City (TW); Jun-Chung HSU, Pingzhen City (TW)

(73) Assignee: KINSUS INTERCONNECT TECHNOLOGY CORP., Taoyuan (TW)

(21) Appl. No.: 14/085,033

(22) Filed: Nov. 20, 2013

(51) Int. Cl. H01B 3/47; H01B 3/40

(52) U.S. Cl. CPC H01B 3/47; H01B 3/40
USPC 428/131

(57) ABSTRACT

An insulation layer structure includes an insulation layer, at least one glass fiber embedded in the insulation layer and at least one opening penetrating through the insulation layer and cutting off the glass fiber. The glass fiber projects from a sidewall of the opening such that the ratio of the length of the glass fiber projecting from the sidewall to the width of the opening is 0.2˜33%. With the glass fiber projecting from the sidewall of the opening, the sidewall of the opening has large surface roughness and the surface area to contact with the electrolyte. As a result, the crystal growth rate for the electrolyte onto the sidewall is accelerated. Therefore, the adhesion between the electroplating layer and the sidewall of the opening is increased, thereby improving the reliability and the yield rate of the product.

### BACKGROUND OF THE INVENTION

1. Field of the Invention

The present invention generally relates to an insulation layer structure, and more specifically to an insulation layer structure with openings allowing glass fiber to project from the sidewall.

2. The Prior Arts

Please refer to FIG. 1, showing the insulation layer structure in the prior arts. As shown in FIG. 1, the insulation layer structure 1 in the prior arts is a sheet structure made of an insulation layer 20 and at least one glass fiber 30. The glass fiber 30 is embedded in the insulation layer 20 to provide mechanical strength for the insulation layer structure 1. Additionally, the insulation layer structure 1 is formed with at least one opening 40 that penetrates through the insulation layer 20 and that cuts off the glass fiber 30.

Traditionally, for the sake of facilities and cost, the opening 40 is primarily formed by mechanically drilling. Though the drilled opening 40 provides a smooth, plane surface, the drilled opening 40 is generally intended to provide electrical connection between the upper and lower circuit layers after the subsequent electroplating process. Obviously, one of the shortcomings in the prior arts is that it is difficult for crystal growth on the smooth opening in the electroplating process. As a result, the time of the electroplating process is prolonged and the cost is increased. Furthermore, the electroplating layer after the electroplating process is weak in the adhesion due to the less contact area with the sidewall and thus easily peeled off by external force. This may cause the final product to fail. Therefore, it greatly needs to provide an insulation layer structure having the electroplating layer with improved adhesion, thereby overcoming the above problems in the prior arts.

### SUMMARY OF THE INVENTION

The primary objective of the present invention is to provide an insulation layer structure, including an insulation layer, at least one glass fiber and at least one opening. The glass fiber is embedded in the insulation layer to form a sheet structure with the insulation layer. The opening penetrates through the insulation layer and cuts off the glass fiber. The glass fiber projects from a sidewall of the opening such that the ratio of the length of the glass fiber projecting from the sidewall to the width of the opening is 0.2˜33%.

The opening of the insulation layer structure according to the present invention is formed by the process of laser beam melting or hot melting. With the different melting points of the glass fiber and the insulation layer, part of the glass fiber projects from the sidewall of the opening such that the sidewall of the opening has large surface roughness and the surface area of the opening to contact with the electrolyte is thus increased in the subsequent electroplating process. The crystal growth rate for the electrolyte onto the sidewall is thus accelerated and meanwhile the time desired for electroplating is greatly reduced. Additionally, the adhesion between the electroplating layer and the sidewall of the opening after the electroplating process is greatly increased so as to improve the reliability and the yield rate of the product.

### BRIEF DESCRIPTION OF THE DRAWINGS

The present invention can be understood in more detail by reading the subsequent detailed description in conjunction with the examples and references made to the accompanying drawings, wherein:

FIG. 1 is a cross sectional view showing the insulation layer structure in the prior arts; and

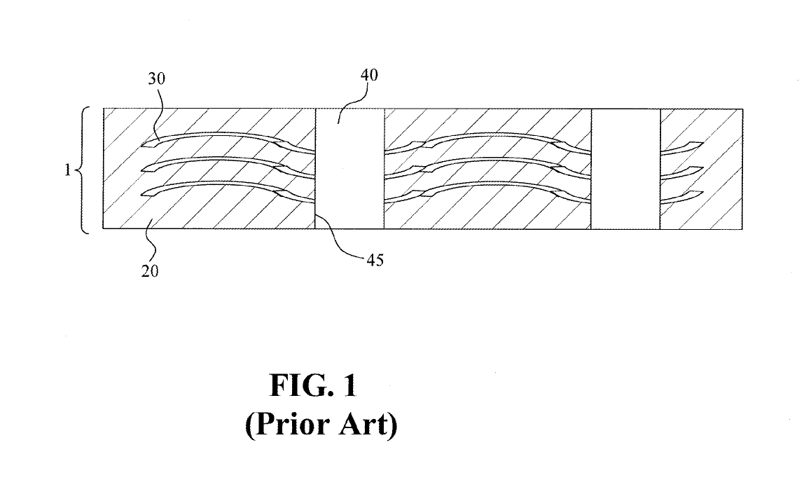

FIG. 2 is a cross-sectional view schematically showing the insulation layer structure according to the present invention.

### DETAILED DESCRIPTION OF THE PREFERRED EMBODIMENTS

The present invention may be embodied in various forms and the details of the preferred embodiments of the present invention will be described in the subsequent content with reference to the accompanying drawings. The drawings (not to scale) show and depict only the preferred embodiments of the invention and shall not be considered as limitations to the scope of the present invention. Modifications of the shape of the present invention shall too be considered to be within the spirit of the present invention.

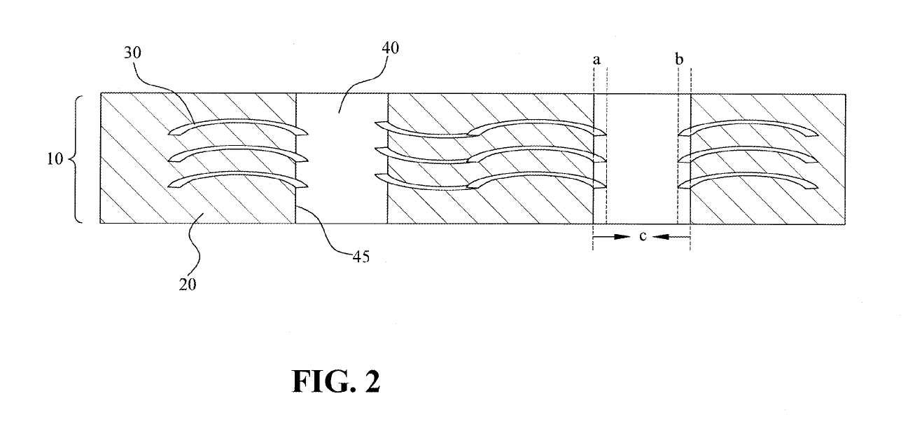

FIG. 2 is a cross-sectional view schematically showing the insulation layer structure according to the present invention. As shown in FIG. 2, the insulation layer structure 10 of the present invention includes an insulation layer 20 and at least one glass fiber 30 to form a sheet structure. Specifically, the insulation layer 20 includes epoxy resin or Bismaleimide Triazine (BT) resin. The glass fiber 30 is embedded in the insulation layer 20 to provide sufficient mechanical strength for the insulation layer 10.

Furthermore, the insulation layer structure 10 is formed with at least one opening 40 that penetrates through the insulation layer 20 and that cuts off the glass fiber 30. Preferably, the opening 40 is formed by the process of laser beam melting or hot melting such that part of the glass fiber 30 projects from the insulation layer 20 and the sidewall 45 of the opening 40 has sufficient roughness. More specifically, the ratio of the total length (that is, a+b in FIG. 2) of the glass fiber 30 projecting from the sidewall 45 of the opening 40 to the width c of the opening 40 is (a+b)/c (that is, 0.2˜33%).

One aspect of the insulation layer structure of the present invention is that the opening 40 is formed by the process of laser beam melting or hot melting, and with the different melting points of the glass fiber 30 and the insulation layer 20, part of the glass fiber 30 can project from the sidewall 45 of the opening 40 such that the sidewall 45 of the opening 40 has larger surface roughness and the surface area of the opening 40 to contact with the electrolyte is thus increased in the subsequent electroplating process. Additionally, the crystal growth rate for the electrolyte onto the sidewall 45 of the opening 40 is thus accelerated and meanwhile the time desired for electroplating is greatly reduced. In particularly, the adhesion between the electroplating layer and the sidewall 45 of the opening 40 after the electroplating process is greatly increased such that the reliability and the yield rate of the product are improved.

Although the present invention has been described with reference to the preferred embodiments, it will be understood that the invention is not limited to the details described thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. An insulation layer structure, comprising:
an insulation layer;
at least one glass fiber embedded in the insulation layer to form a sheet structure with the insulation layer; and
at least one opening penetrating through the insulation layer and the at least one glass fiber, wherein the glass fiber projects from a sidewall of the opening, and a ratio of a total length of the glass fiber projecting from the sidewall to a width of the opening is 0.2˜33%.

2. The insulation layer structure as claimed in claim 1, wherein the opening is formed by a process of laser beam melting or hot melting.

3. The insulation layer structure as claimed in claim 1, wherein the insulation layer includes epoxy resin or Bismaleimide Triazine (BT) resin.
